(19) United States
(12) Patent Application Publication
(10) Pub. No.: US 2024/0348954 A1
(43) Pub. Date: Oct. 17, 2024

(54) DATA PHASE RECOVERY METHOD, SYSTEM, DEVICE AND STORAGE MEDIUM FOR BURST CODE STREAM

(71) Applicant: SHENZHEN PANGO MICROSYSTEMS CO.,LTD, SHENZHEN (CN)

(72) Inventors: JIN ZHANG, SHENZHEN (CN); SIYUAN WU, SHENZHEN (CN); XINJIAN CHEN, SHENZHEN (CN)

(21) Appl. No.: 18/757,541

(22) Filed: Jun. 28, 2024

Related U.S. Application Data
(63) Continuation of application No. PCT/CN2022/091306, filed on May 6, 2022.

(30) Foreign Application Priority Data
Dec. 28, 2021 (CN) 202111630018.6

(51) Int. Cl. H04Q 11/00; H04J 3/06

(52) U.S. Cl. CPC H04Q 11/0062; H04J 3/0617; H04Q 2011/0079; H04Q 2011/0086

(57) ABSTRACT

The present application provides a data phase recovery method, system, device and storage medium for burst code stream. The method includes: in case of detecting that data burst transmission occurs on a target peer device and detecting that a data pause signal is in an invalid state, increasing a data transmission bandwidth within a preset time specified in a transmission protocol, until a clock and data recovery (CDR) completes data locking; reducing the increased data transmission bandwidth after detecting that the CDR completes data locking. In the embodiment of the present application, by combining fast locking and slow tracking, the data transmission bandwidth is only increased within the preset time specified in the protocol, rather than continuously increasing the bandwidth, which will not have a significant impact on the stability of the link.

### CROSS-REFERENCE TO RELATED APPLICATIONS

This application is a Bypass Continuation Application of PCT International Application No. PCT/CN2022/091306 filed on May 6, 2022, which claims priority to Chinese Patent Application No. 202111630018.6, filed on Dec. 28, 2021 and entitled “DATA PHASE RECOVERY METHOD, SYSTEM, DEVICE, AND STORAGE MEDIUM FOR BURST CODE STREAM”, the entire contents of which are incorporated herein by reference.

### FIELD OF THE DISCLOSURE

The present application relates to the field of communication technology, specifically to a data phase recovery method, system, device and storage medium for burst code stream.

### BACKGROUND

In order to take advantage of huge bandwidth of optical transmission, time-division multiplexing technology is often used in current communications to multiplex some low-speed signals onto a high-speed optical fiber. Due to complexity of network synchronization, it is difficult to achieve complete synchronization of signals in different time periods, and there are always more or less differences in frequency or phase. This puts forward some special requirements for clock and data recovery (CDR) at a receiving end. For high-speed serial buses, generally, clock information is embedded into transmitted data stream through data encoding, and then the clock information is extracted through the clock and data recovery at the receiving end, and data is sampled with this recovered clock. Therefore, a clock recovery circuit is essential for transmission and reception of high-speed serial signals.

Especially in many communication services, it is often necessary to transmit some data with burst characteristics, which is referred as burst data. The burst data has the characteristics of random transmission time and short duration. The clock recovery of burst data at the receiving end requires not only high-speed clock and data recovery capability (generally requiring a clock frequency of more than 1 GHz), but also a very fast recovery time (generally within a few hundred nanoseconds). Such clock recovery for burst data is usually referred as burst clock and data recovery (BCDR). FIG. 1 is a diagram of CDR in the related art. As shown in FIG. 1, the principle of the CDR circuit is to track clock drift and part of jitter at a transmitting end to ensure correct data sampling, and a receiving module in the CDR circuit first maps byte signal sent from an upper protocol to DC-balanced encoding, and parallel-to-serial conversion is used to serialize 10-bit encoding result. The high-speed and low jitter clock required for the parallel-to-serial conversion is provided by the phase-locked loop. A sending module converts high-speed serial code stream at CMOS level into a differential signal with strong noise resistance, which is sent to a receiver through backplane connection or fiber optic channel. At the receiving end, a receiving module restores a received low-swing differential signal to a CMOS-level serial signal, and CDR extracts a clock signal from the serial signal to complete the best sampling of the serial signal. The serial-to-parallel conversion uses a clock recovered by the CDR to convert the serial signals into parallel data, the parallel data is decoded and restored to a byte signal, and the byte signal is sent to an upper protocol chip, thereby completing an entire information transmission process.

Under the XGS-PON protocol, data sent by a peer device will be interrupted and transmitted in bursts, thus the CDR at the receiving end is required to be able to stably complete locking of recovered data within a time specified in the agreement. However, the inventor found that the existing CDR is designed to track data changes according to a fixed bandwidth. In order to quickly lock data in a short period of time, it is necessary to increase the bandwidth, but increasing the bandwidth will reduce stability of the link, and reducing the bandwidth cannot meet the locking time requirement specified in the agreement.

### SUMMARY

The present application provides a data phase recovery method, system, device, and storage medium for burst stream, with a main object of completing CDR data locking within a time specified in the protocol.

The technical solution of the present application is as follows. A data phase recovery method for burst stream is provided and includes:
data phase recovery method for burst code stream, comprising:
in case of detecting that data burst transmission occurs on a target peer device and detecting that a data pause signal is in an invalid state, increasing a data transmission bandwidth within a preset time specified in a transmission protocol, until a clock and data recovery (CDR) completes data locking;
reducing the increased data transmission bandwidth after detecting that the CDR completes data locking.

Another technical solution of the present application is as follows. A data phase recovery system for burst stream is provided and includes:
a fast locking module configured to, in case of detecting that data burst transmission occurs on a target peer device and detecting that a data pause signal is in an invalid state, increase a data transmission bandwidth within a preset time specified in a transmission protocol, until a clock and data recovery (CDR) completes data locking; and
a slow tracking module configured to reduce the increased data transmission bandwidth after detecting that the CDR completes data locking.

Another technical solution of the present application is as follows. A computer device is provided and includes: a memory, a processor, and a computer program stored in the memory and executable on the processor; wherein the processor executes the computer program to perform:
in case of detecting that data burst transmission occurs on a target peer device and detecting that a data pause signal is in an invalid state, increasing a data transmission bandwidth within a preset time specified in a transmission protocol, until a clock and data recovery (CDR) completes data locking;
reducing the increased data transmission bandwidth after detecting that the CDR completes data locking.

Another technical solution of the present application is as follows. A computer storage medium is provided and includes a computer program stored thereon; wherein the computer program, when executed by a processor, causes the processor to perform:
in case of detecting that data burst transmission occurs on a target peer device and detecting that a data pause signal is in an invalid state, increasing a data transmission bandwidth within a preset time specified in a transmission protocol, until a clock and data recovery (CDR) completes data locking;
reducing the increased data transmission bandwidth after detecting that the CDR completes data locking.

The present application provides a data phase recovery method, system, device and storage medium for burst code stream. When data burst transmission occurs, the data transmission bandwidth is increased within the preset time specified in the XGS-PON protocol. After the data transmission bandwidth is increased, an amount of data transmitted per unit time will becomes larger, so that the CDR circuit can realize fast locking of data. After the fast locking is completed, the increased data transmission bandwidth will be reduced and returned to the normal data transmission bandwidth, and then the CDR will complete tracking of the data. In the embodiment of the present application, by combining fast locking and slow tracking, the data transmission bandwidth is only increased within the preset time specified in the protocol, rather than continuously increasing the bandwidth, which will not have a significant impact on the stability of the link. This not only meets the stability of the link, but also meets the requirements for locking time.

### BRIEF DESCRIPTION OF THE DRAWINGS

FIG. 1 is a diagram of a CDR in the related art;

FIG. 2 is a flow chart of a data phase recovery method for burst code stream according to an embodiment of the present application;

FIG. 3 is a diagram of a CDR according to an embodiment of the present application;

FIG. 4 is a flow chart of a data phase recovery method for burst code stream according to a preferred embodiment of the present application;

FIG. 5 is a schematic diagram of a data phase recovery system according to an embodiment of the present application; and

FIG. 6 is a schematic diagram of a computer device according to an embodiment of the present application.

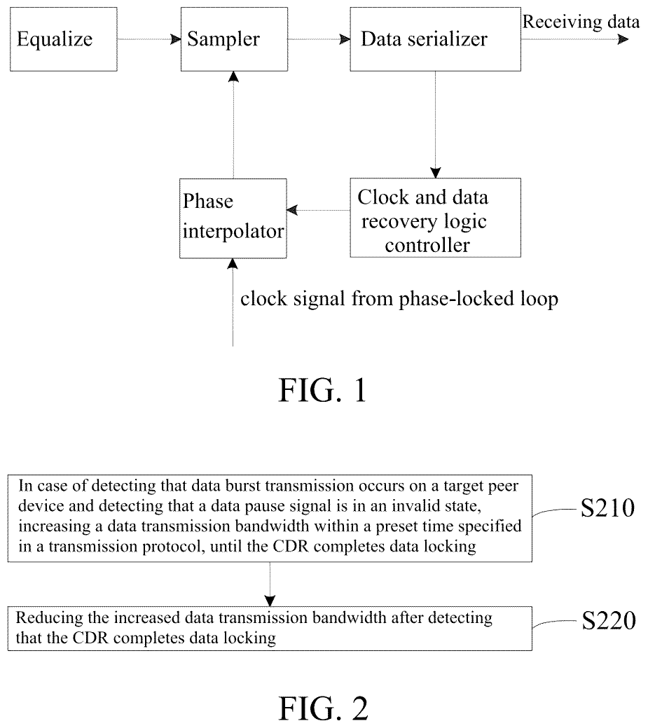

The realization of objects, functional features and advantages of the present application will be further described in conjunction with embodiments with reference to the accompanying drawings.

### DETAILED DESCRIPTION OF PREFERRED EMBODIMENTS

It is to be noted that specific embodiments described here are only used to explain the present application, and are not intended to limit the present application.

FIG. 2 is a flow chart of a data phase recovery method for burst code stream according to an embodiment of the present application. As shown in FIG. 2, the method includes the following steps.

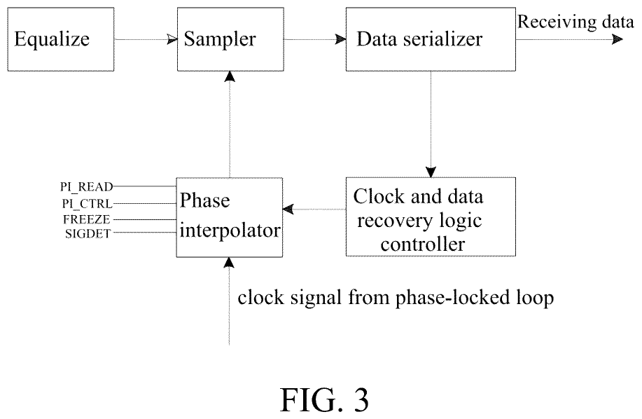

FIG. 3 is a diagram of a CDR according to an embodiment of the present application. As shown in FIG. 3, the CDR in the embodiment of the present application adds PI configuration port (PI_CTRL), PI real-time monitoring port (PI_READ) and PI pause counting port (FREEZE) to the existing CDR architecture. Specifically, 3 pins are drawn from a phase interpolator in the CDR circuit, which are respectively used for the PI configuration port, PI real-time monitoring port and the PI pause counting port. The PI configuration port is used for PI write port, which can assign real-time phase values to the phase interpolator. The PI real-time monitoring port is used to read a PI value in real time, which can be regarded as reading a real-time phase value of the phase interpolator. The PI pause counting port is used to set a value for an artificial data pause signal.

S210: in case of detecting that data burst transmission occurs on a target peer device and detecting that a data pause signal is in an invalid state, increasing a data transmission bandwidth within a preset time specified in a transmission protocol, until the CDR completes data locking.

For the data burst transmission occurred on the target peer device, the target peer device is a device connected to the CDR. There may be multiple devices connected to the CDR. One of the connected devices is selected as the target peer device in the embodiment of the present application, and this target peer device is used as an example for illustration, and an execution process of other connected devices is the same.

After detecting the data burst transmission occurs on the target peer device, a status of the data pause signal is detected. If the data pause signal is invalid, then within the time specified in the XGS-PON protocol, the initially set data transmission bandwidth is increased. After the data transmission bandwidth is increased, an amount of data transmitted per unit time will increase, thereby speeding up the CDR's locking of the data.

In the embodiment of the present application, the data transmission bandwidth is increased within a preset time, thereby realizing fast locking of data within the preset time specified in the XGS-PON protocol.

S220: reducing the increased data transmission bandwidth after detecting that the CDR completes data locking.

If it is detected that the CDR completes data locking, the data transmission bandwidth is still the increased bandwidth at this time. If the data transmission bandwidth is kept large, the link stability will be reduced. Therefore, in order to maintain the link stability, the increased data transmission bandwidth can be reduced. The reduction here may be to reduce the increased data transmission bandwidth, or to change the increased data transmission bandwidth to an initial value.

In the embodiment of the present application, the data transmission bandwidth is reduced outside the preset time, thereby realizing slow tracking of the locked data and ensuring the stability of the link.

According to the data phase recovery method for burst code stream provided in the present application, when data burst transmission occurs, the data transmission bandwidth is increased within the preset time specified in the XGS-PON protocol. After the data transmission bandwidth is increased, an amount of data transmitted per unit time will becomes larger, so that the CDR circuit can realize fast locking of data. After the fast locking is completed, the increased data transmission bandwidth will be reduced and returned to the normal data transmission bandwidth, and then the CDR will complete tracking of the data. In the embodiment of the present application, by combining fast locking and slow tracking, the data transmission bandwidth is only increased within the preset time specified in the protocol, rather than continuously increasing the bandwidth, which will not have a significant impact on the stability of the link. This not only meets the stability of the link, but also meets the requirements for locking time.

On the basis of the above embodiment, preferably, before, in case of detecting that data burst transmission occurs on a target peer device and detecting that a data pause signal is in an invalid state, increasing a data transmission bandwidth within a preset time specified in a transmission protocol, until the CDR completes data locking, the method further includes:
reading a real-time phase value of the phase interpolator in the CDR;
according to the real-time phase value, determining a state of the CDR; in case of determining that the CDR is not in a convergent state, assigning a preset phase value to the phase value of the phase interpolator.

Specifically, before fast locking, the following steps can be taken to speed up the convergence of the CDR, thereby further reducing the time for CDR to quickly lock data. The steps specifically are as follows.
through the PI_READ port, reading a real-time phase value of the phase interpolator, that is, the PI value. For the same target peer device, real-time phase values when the CDR is in a converged state at different times should not differ much, and the reason for the difference is that voltage and ambient temperature change during each data transmission process, and thus, it can be determined whether the CDR is in the converged state according to the read real-time phase value. Specifically, an interval where the phase value is located when the CDR is in the converged state, can be determined based on historical experience; if the real-time phase value in the current transmission is in this interval, it is determined that the CDR is in the converged state; otherwise, it is determined that the CDR is in a non-converged state.

If the CDR is in the convergent state, no operation is required. If the CDR is not in the convergent state, the real-time phase value can be adjusted according to the preset phase value, thereby speeding up the convergence time of the CDR and further reducing the time for the CDR to lock data.

On the basis of the above embodiment, preferably, the preset phase value is obtained according to phase values of the phase interpolator when the CDR converges during burst data transmissions of the target device at different historical moments.

Specifically, for the same target peer device, the real-time phase values when the CDR converges at different times should have little difference. In this embodiment of the present application, the preset phase value is selected according to the real-time phase values when the CDR converges at different times, and the preset phase value is assigned to the real-time phase value, thereby adjusting the real-time phase of the phase interpolator.

On the basis of the above embodiment, preferably, the method further includes:
in case that the target device experiences a data burst transmission for the first time, setting an initial phase value of the phase interpolator in the CDR with the preset phase value.

In case that the target peer device experiences the data burst transmission for the first time, the initial phase value of the phase interpolator in the CDR is set with the preset phase value.

On the basis of the above embodiment, preferably, the data pause signal includes an artificial data pause signal, and the method further includes:
in case of detecting that the target peer device experiences a sudden data interruption, setting the artificial data pause signal to be valid;
in case of detecting that the artificial data pause signal is valid, the CDR stopping phase counting.

Specifically, the data pause signal includes the artificial data pause signal. The so-called artificial data pause signal means a manually set signal. An operation state of the CDR can be controlled by manually setting the signal. In a specific implementation process, in case of detecting that the target peer device experiences a sudden data interruption, then the artificial data pause signal is set to be valid, that is, the artificial data pause signal is set through the FREEZE port, and after the port is set to be valid, the CDR stops phase counting.

In the related art, when a sudden data interruption occurs, since the CDR is not artificially set to stop working, the phase value will keep spinning in the CDR, and the CDR is very easy to hang up. In the embodiment of the present application, the data pause signal can be manually set to make the CDR stop phase counting, thereby preventing the CDR from hanging after data interruption.

On the basis of the above embodiment, preferably, the data pause signal includes an abnormal data pause signal, and the method further includes:
in case of detecting that an abnormality occurs in the CDR, setting the abnormal data pause signal to be valid;
in case of detecting that the abnormal data pause signal is valid, the CDR stopping phase counting.

In the embodiment of the present application, the data pause signal further includes the abnormal data pause signal. The abnormal data pause signal is used to detect a natural abnormality of the CDR. In case of detecting that an abnormality occurs in the CDR, the abnormal data pause signal is set to be valid. When the abnormal data pause signal is in a valid state, the CDR will also stop phase counting.

On the basis of the above embodiment, preferably, the method further includes:

In case of detecting that the data burst transmission ends, setting the data pause signal to be invalid.

Specifically, if the data burst transmission ends, both of the artificial data pause signal and the abnormal data pause signal are set to an invalid state, to prepare for the next data burst.

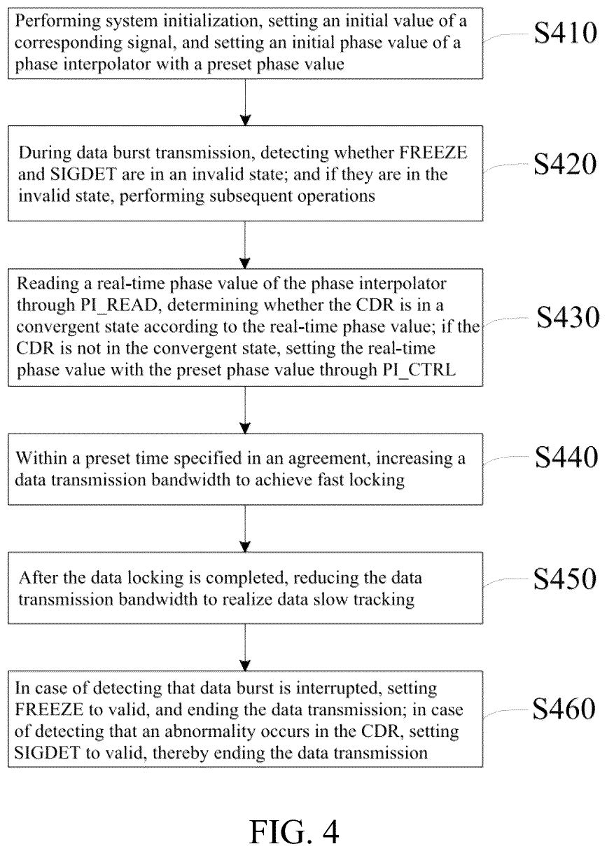

FIG. 4 is a flow chart of a data phase recovery method for burst code stream according to a preferred embodiment of the present application. As shown in FIG. 4, the method includes:
S410: performing system initialization, setting an initial value of a corresponding signal, and setting an initial phase value of a phase interpolator with a preset phase value;
S420: during data burst transmission, detecting whether FREEZE and SIGDET are in an invalid state; and if they are in the invalid state, performing subsequent operations;
S430: reading a real-time phase value of the phase interpolator through PI_READ, determining whether the CDR is in a convergent state according to the real-time phase value; if the CDR is not in the convergent state, setting the real-time phase value with the preset phase value through PI_CTRL;
S440: within a preset time specified in an agreement, increasing a data transmission bandwidth to achieve fast locking;
S450: after the data locking is completed, reducing the data transmission bandwidth to realize data slow tracking;
S460: in case of detecting that data burst is interrupted, setting FREEZE to valid, and ending the data transmission; in case of detecting that an abnormality occurs in the CDR, setting SIGDET to valid, thereby ending the data transmission.

In summary, according to the data phase recovery method for burst code stream provided in the embodiment of the present application, when data burst transmission occurs, the data transmission bandwidth is increased within the preset time specified in the XGS-PON protocol. After the data transmission bandwidth is increased, an amount of data transmitted per unit time will becomes larger, so that the CDR circuit can realize fast locking of data. After the fast locking is completed, the increased data transmission bandwidth will be reduced and returned to the normal data transmission bandwidth, and then the CDR will complete tracking of the data. In the embodiment of the present application, by combining fast locking and slow tracking, the data transmission bandwidth is only increased within the preset time specified in the protocol, rather than continuously increasing the bandwidth, which will not have a significant impact on the stability of the link. This not only meets the stability of the link, but also meets the requirements for locking time.

Further, the real-time phase value can be adjusted according to the preset phase value, so that the convergence time of the CDR can be reduced, and the time for the CDR to lock data can be further reduced.

Finally, in the related art, when a sudden data interruption occurs, since the CDR is not artificially set to stop working, the phase value will keep spinning in the CDR, and the CDR is very easy to hang up. In the embodiment of the present application, the data pause signal can be manually set to make the CDR stop phase counting, thereby preventing the CDR from hanging after data interruption.

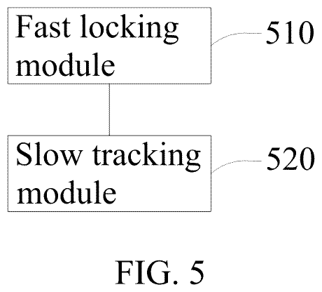

FIG. 5 is a schematic diagram of a data phase recovery system according to an embodiment of the present application. As shown in FIG. 5, the system includes a fast locking module 510 and a slow tracking module 520.

The fast locking module 510 is configured to, in case of detecting that data burst transmission occurs on a target peer device and detecting that a data pause signal is in an invalid state, increase a data transmission bandwidth within a preset time specified in a transmission protocol, until the CDR completes data locking.

The slow tracking module 520 is configured to reduce the increased data transmission bandwidth after detecting that the CDR completes data locking.

This embodiment is a system embodiment corresponding to the above method, and its implementation process is the same as that of the above method embodiment. Details can refer to the above method embodiment, and will not be repeated here in this system embodiment.

On the basis of the above embodiment, preferably, a reading module and a determining module are further included.

The reading module is configured to read a real-time phase value of the phase interpolator in the CDR.

The determining module is configured to, according to the real-time phase value, determine a state of the CDR; in case of determining that the CDR is not in a convergent state, assign a preset phase value to the phase value of the phase interpolator.

On the basis of the above embodiment, preferably, the preset phase value is obtained according to phase values of the phase interpolator when the CDR converges during burst data transmissions of the target device at different historical moments.

On the basis of the above embodiment, preferably, a first-time module is further included.

The first-time module is configured to, in case that the target device experiences a data burst transmission for the first time, set an initial phase value of the phase interpolator in the CDR with the preset phase value.

On the basis of the above embodiment, preferably, the data pause signal includes an artificial data pause signal, and an artificial pause module and a first stop module are further includes.

The artificial pause module is configured to, in case of detecting that the target peer device experiences a sudden data interruption, set the artificial data pause signal to be valid.

The first stop module is configured to, in case of detecting that the artificial data pause signal is valid, stop phase counting by the CDR.

On the basis of the above embodiment, preferably, the data pause signal includes an abnormal data pause signal, and an abnormal data pause module and a second stop module are further included.

The abnormal data pause module is configured to, in case of detecting that an abnormality occurs in the CDR, set the abnormal data pause signal to be valid.

The second stop module is configured to, in case of detecting that the abnormal data pause signal is valid, stop phase counting, by the CDR.

On the basis of the above embodiment, preferably, a reset unit is further included.

The reset unit is configured to, in case of detecting that the data burst transmission ends, set the data pause signal to be invalid.

Part or all of various modules in the above data phase recovery system for burst code stream can be realized by software, hardware and a combination thereof. The above modules may be embedded in or independent of a processor in a computer device in the form of hardware, and may also be stored in a memory of the computer device in the form of software so that the processor can call and execute corresponding operations of the above modules.

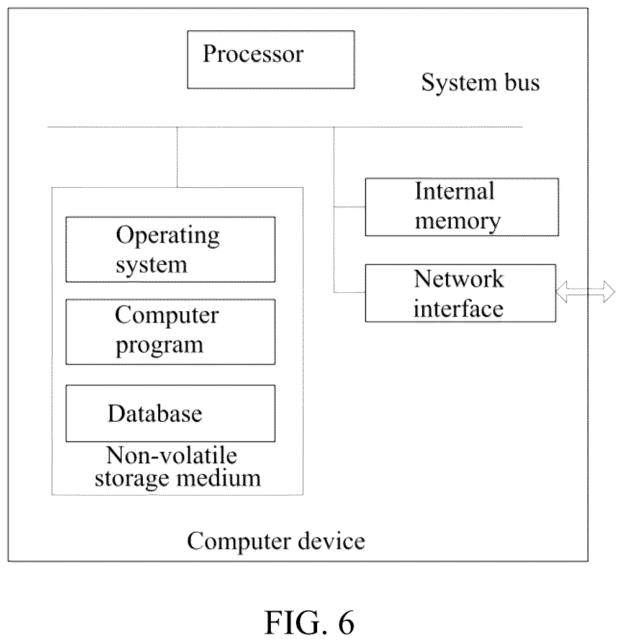

FIG. 6 is a schematic diagram of a computer device according to an embodiment of the present application. The computer device may be a server, and its internal structure may be as shown in FIG. 6. The computer device includes a processor, a memory, a network interface and a database connected by a system bus. The processor of the computer device is used to provide calculation and control capabilities. The memory of the computer device includes a computer storage medium and an internal memory. The computer storage medium stores an operating system, computer programs and databases. The internal memory provides an environment for operation of the operating system and computer programs in the computer storage medium. The database of the computer device is used to store data generated or obtained during the execution of the data phase recovery method for burst code stream, such as data pause signal and preset time. The network interface of the computer device is used to communicate with an external terminal via a network connection. When the computer program is executed by the processor, the data phase recovery method for burst code stream is implemented.

One embodiment provides a computer device, including a memory, a processor, and a computer program stored on the memory and executable on the processor. When the processor executes the computer program, steps of the above data phase recovery method for burst code stream are implemented. Or, when the processor executes the computer program, functions of the modules/units in the embodiment of the data phase recovery system for burst code stream are implemented.

One embodiment provides a computer storage medium. A computer program is stored on the computer storage medium. The computer-readable storage medium may be non-volatile or volatile. When the computer program is executed by a processor, steps of the above data phase recovery method for burst code stream are implemented. Or, when the computer program is executed by the processor, functions of the modules/units in the embodiment of the data phase recovery system for burst code stream are implemented.

Those skilled in the art can understand that all or part of the processes in the above embodiment of methods can be completed by instructing the relevant hardware through a computer program, and the computer program can be stored in a non-volatile computer-readable storage medium. When the computer program is executed, the processes of the embodiments of the above methods are implemented. Any reference to memory, storage, database or other media used in the embodiments provided in this application may include non-volatile and/or volatile memory. The non-volatile memory may include read-only memory (ROM), programmable ROM (PROM), electrically programmable ROM (EPROM), electrically erasable programmable ROM (EEPROM) or flash memory. The volatile memory may include random access memory (RAM) or external cache memory. As an illustration and not limitation, RAM is available in many forms, such as static RAM (SRAM), dynamic RAM (DRAM), synchronous DRAM (SDRAM), double data rate SDRAM (DDRSDRAM), enhanced SDRAM (ESDRAM), synchronous link DRAM (SLDRAM), memory bus (Rambus) direct RAM (RDRAM), direct memory bus dynamic RAM (DRDRAM), and memory bus dynamic RAM (RDRAM).

Those skilled in the art can clearly understand that for convenience and simplicity of description, divisions of the above functional units and modules are merely used as an example. In actual applications, the above functions can be assigned to different functional units and modules as needed, that is, internal structure of the device can be divided into different functional units or modules to complete all or part of the functions described above.

The embodiments described above are only used to illustrate the technical solutions of the present application, rather than to limit the same. Although the present application has been described in detail with reference to the aforementioned embodiments, those skilled in the art should understand that the technical solutions described in the aforementioned embodiments may still be modified, or some of the technical features may be replaced by equivalents. Such modifications or replacements do not deviate the essence of the corresponding technical solutions from the spirit and scope of the technical solutions of the embodiments of the present application, and should all be included in the protection scope of the present application.

What is claimed is:

1. A data phase recovery method for burst code stream, comprising:
in case of detecting that data burst transmission occurs on a target peer device and detecting that a data pause signal is in an invalid state, increasing a data transmission bandwidth within a preset time specified in a transmission protocol, until a clock and data recovery (CDR) completes data locking;
reducing the increased data transmission bandwidth after detecting that the CDR completes data locking.

2. The method according to claim 1, wherein before, in case of detecting that data burst transmission occurs on a target peer device and detecting that a data pause signal is in an invalid state, increasing a data transmission bandwidth within a preset time specified in a transmission protocol, until a clock and data recovery (CDR) completes data locking, the method further includes:
reading a real-time phase value of a phase interpolator in the CDR;
according to the real-time phase value, determining a state of the CDR; in case of determining that the CDR is not in a convergent state, assigning a preset phase value to the phase value of the phase interpolator.

3. The method according to claim 2, wherein the preset phase value is obtained according to phase values of the phase interpolator when the CDR converges during burst data transmissions of the target device at different historical moments.

4. The method according to claim 3, further comprising:
in case that the target device experiences a data burst transmission for the first time, setting an initial phase value of the phase interpolator in the CDR with the preset phase value.

5. The method according to claim 1, wherein the data pause signal includes an artificial data pause signal, and the method further includes:
in case of detecting that the target peer device experiences a sudden data interruption, setting the artificial data pause signal to be valid;
in case of detecting that the artificial data pause signal is valid, the CDR stopping phase counting.

6. The method according to claim 1, wherein the data pause signal includes an abnormal data pause signal, and the method further includes:
in case of detecting that an abnormality occurs in the CDR, setting the abnormal data pause signal to be valid;
in case of detecting that the abnormal data pause signal is valid, the CDR stopping phase counting.

7. The method according to claim 1, further comprising:
in case of detecting that the data burst transmission ends, setting the data pause signal to be invalid.

8. A computer device, comprising: a memory, a processor, and a computer program stored in the memory and executable on the processor; wherein the processor executes the computer program to perform:
in case of detecting that data burst transmission occurs on a target peer device and detecting that a data pause signal is in an invalid state, increasing a data transmission bandwidth within a preset time specified in a transmission protocol, until a clock and data recovery (CDR) completes data locking;
reducing the increased data transmission bandwidth after detecting that the CDR completes data locking.

9. The computer device according to claim 8, wherein before, in case of detecting that data burst transmission occurs on a target peer device and detecting that a data pause signal is in an invalid state, increasing a data transmission bandwidth within a preset time specified in a transmission protocol, until a clock and data recovery (CDR) completes data locking, the processor executes the computer program to further perform:
reading a real-time phase value of a phase interpolator in the CDR;
according to the real-time phase value, determining a state of the CDR; in case of determining that the CDR is not in a convergent state, assigning a preset phase value to the phase value of the phase interpolator.

10. The computer device according to claim 9, wherein the preset phase value is obtained according to phase values of the phase interpolator when the CDR converges during burst data transmissions of the target device at different historical moments.

11. The computer device according to claim 10, further comprising:
in case that the target device experiences a data burst transmission for the first time, setting an initial phase value of the phase interpolator in the CDR with the preset phase value.

12. The computer device according to claim 8, wherein the data pause signal includes an artificial data pause signal, and the processor executes the computer program to further perform:
in case of detecting that the target peer device experiences a sudden data interruption, setting the artificial data pause signal to be valid;
in case of detecting that the artificial data pause signal is valid, the CDR stopping phase counting.

13. The computer device according to claim 9, wherein the data pause signal includes an abnormal data pause signal, and the processor executes the computer program to further perform:
in case of detecting that an abnormality occurs in the CDR, setting the abnormal data pause signal to be valid;
in case of detecting that the abnormal data pause signal is valid, the CDR stopping phase counting.

14. The computer device according to claim 8, further comprising:
in case of detecting that the data burst transmission ends, setting the data pause signal to be invalid.

15. A computer storage medium, comprising a computer program stored thereon; wherein the computer program, when executed by a processor, causes the processor to perform:
in case of detecting that data burst transmission occurs on a target peer device and detecting that a data pause signal is in an invalid state, increasing a data transmission bandwidth within a preset time specified in a transmission protocol, until a clock and data recovery (CDR) completes data locking;
reducing the increased data transmission bandwidth after detecting that the CDR completes data locking.

16. The computer storage medium according to claim 15, wherein before, in case of detecting that data burst transmission occurs on a target peer device and detecting that a data pause signal is in an invalid state, increasing a data transmission bandwidth within a preset time specified in a transmission protocol, until a clock and data recovery (CDR) completes data locking, the computer program, when executed by the processor, causes the processor to further perform:
reading a real-time phase value of a phase interpolator in the CDR;
according to the real-time phase value, determining a state of the CDR; in case of determining that the CDR is not in a convergent state, assigning a preset phase value to the phase value of the phase interpolator.

17. The computer storage medium according to claim 16, wherein the preset phase value is obtained according to phase values of the phase interpolator when the CDR converges during burst data transmissions of the target device at different historical moments.

18. The computer storage medium according to claim 17, further comprising:
in case that the target device experiences a data burst transmission for the first time, setting an initial phase value of the phase interpolator in the CDR with the preset phase value.

19. The computer storage medium according to claim 15, wherein the data pause signal includes an artificial data pause signal, and the computer program, when executed by the processor, causes the processor to further perform:
in case of detecting that the target peer device experiences a sudden data interruption, setting the artificial data pause signal to be valid;
in case of detecting that the artificial data pause signal is valid, the CDR stopping phase counting.

20. The computer storage medium according to claim 15, wherein the data pause signal includes an abnormal data pause signal, and the computer program, when executed by the processor, causes the processor to further perform:
in case of detecting that an abnormality occurs in the CDR, setting the abnormal data pause signal to be valid;
in case of detecting that the abnormal data pause signal is valid, the CDR stopping phase counting.
